(19) United States
(12) Patent Application Publication
(10) Pub. No.: US 2026/0328288 A1
(43) Pub. Date: Oct. 22, 2026

(54) LOCKING DEVICE, ELECTRIC MOTOR DRIVE UNIT, AND VEHICLE

(71) Applicant: Schaeffler Technologies AG & Co. KG, Herzogenaurach (DE)

(72) Inventors: Jens HENRICH, Schmitten (DE); Karl Martin FRITSCH, Battenberg (DE); Christof HEEGER, Gelnhausen (DE); Philip KIEPER, Königstein (DE)

(21) Appl. No.: 18/993,888

(22) PCT Filed: Jul. 4, 2023
(86) PCT No.: PCT/EP2023/068373

§ 371 Date: Jan. 13, 2025

(30) Foreign Application Priority Data
Jul. 15, 2022 (DE) 10 2022 207 256.1

(51) Int. Cl. F16H 63/34; H02K 7/116

(52) U.S. Cl. CPC F16H 63/3458; H02K 7/1166

(57) ABSTRACT

A locking apparatus for an electric motor drive unit having a locking mechanism for locking a lockable shaft of the electric motor drive unit and an electric drive for actuating the locking mechanism which in addition to the locking mechanism is received by a locking apparatus housing. The locking mechanism has a first positive-locking element having an inner tooth arrangement and a second shaft-side positive-locking element which has an outer tooth arrangement and with respect to which the first positive-locking element can be actuated in a positive-locking manner in an axial travel movement and longitudinally with respect to the shaft. On the shaft-side positive-locking element at the end face and facing the first positive-locking element there is a tapered portion having a centering action and against which the inner tooth arrangement can strike to orientate the two positive-locking elements with respect to each other.

### CROSS REFERENCE TO RELATED APPLICATIONS

This is a U.S. national stage of Application No. PCT/EP2023/068373 filed Jul. 4 2023. Priority is claimed on German Application No. DE 10 2022 207 256.1 filed Jul. 15, 2022, the contents of which are incorporated herein by reference.

### BACKGROUND OF THE INVENTION

### 1. Field of the Invention

The disclosure relates to a locking apparatus, an electric motor drive unit having such a locking apparatus, and a vehicle having such an electric motor drive unit.

### 2. Description of the Related Art

The locking apparatus proposed in the context of this disclosure represents a further development of the locking apparatuses described in the German patent applications with the file references 10 2021 213 737.7 and 10 2021 213 739.3.

### SUMMARY OF THE INVENTION

An object forming the basis of one aspect of the invention is to provide an improved locking apparatus, in particular for a vehicle.

A locking apparatus for an electric motor drive unit is proposed. The locking apparatus has in this instance a locking mechanism for locking a lockable shaft of the electric motor drive unit and an electric drive for actuating the locking mechanism which in addition to the locking mechanism is received by a housing of the locking apparatus.

The locking mechanism comprises in this instance a positive-locking element that can be actuated in an axial travel movement and longitudinally with respect to the shaft and which can be joined at least partially in a positive-locking manner to a shaft-side complement within a positive-locking region in order to lock the shaft.

This actuatable positive-locking element can in this instance in a state, bearing on the shaft-side complement at the front, be engaged, pretensioned or tensioned longitudinally with respect to the shaft by at least one resilient force transmission element in a defined manner with respect to the shaft-side complement.

In this instance, the actuatable positive-locking element is supported in a locking state of the shaft, in which the actuatable positive-locking element and the shaft-side complement engage in each other in the positive-locking region of the locking mechanism, with respect to a housing portion of an electric motor drive unit to which the locking actuator is fitted.

The locking mechanism has in this instance in the positive-locking region and in the circumferential direction of the shaft movement play between the actuatable positive-locking element and the shaft-side complement which together with the said or above-mentioned pretensioning/tensioning of the actuatable positive-locking element with respect to the shaft-side complement enables an engagement of the actuatable positive-locking element in the shaft-side complement or a joining of the actuatable positive-locking element with the shaft-side complement.

A shaft-side complement is in this instance intended to be understood to be a counter-piece on the shaft with respect to the actuatable positive-locking element which is configured or formed in the positive-locking region in an accordingly complementary manner to the actuatable positive-locking element. In this instance, it may be a correspondingly formed portion of the shaft itself or a separate and correspondingly formed element which is joined to the shaft and which cooperates in a positive-locking manner with the actuatable positive-locking element.

A resilient force transmission element is in this instance intended to be understood to be a mechanical energy store for resilient pretensioning/tensioning of the actuatable positive-locking element with respect to the shaft-side complement, for instance in the form of at least one separate spring or a separate resilient element and/or in the form of at least one resilient element portion which can be integrated in the actuatable positive-locking element. This energy store pretensions the actuatable positive-locking element with respect to the shaft-side complement until the shaft assumes or undergoes a suitable orientation for a positive-locking relative to the actuatable positive-locking element. As soon as such an orientation is present, this energy store presses the actuatable positive-locking element for engagement into the shaft-side complement so that the shaft is locked or blocked.

In addition, the locking mechanism can be actuated in an energy-saving manner since it does not require high actuation forces to be applied either for the said actuation or for the said pretensioning. This is because, during the joining of the actuatable positive-locking element to the shaft-side complement, only the actuatable positive-locking element and not also the element to be locked of a drive train is moved.

In this instance, the locking mechanism has a first positive-locking element having an inner tooth arrangement and a second, shaft-side positive-locking element having an outer tooth arrangement, against which the first positive-locking element can be actuated in an axial travel movement and longitudinally with respect to the shaft in a positive-locking manner.

In this instance, there is formed on the shaft-side positive-locking element at the end face and facing the first positive-locking element a centrally acting tapering portion against which the inner tooth arrangement can strike in order to orientate the two positive-locking elements with respect to each other.

A uniform force distribution over the circumference of the two positive-locking elements is thereby ensured in the joined state.

In one embodiment, a multifunctional shaft adapter, which is substantially produced from a plastics material and in which contacts for remote excitation of a rotor, which is connected to the shaft, of a synchronous machine of the electric motor drive unit are embedded, for connection to the lockable shaft is additionally received by the housing of the locking apparatus, wherein the plastics material of the shaft adapter is connected to the shaft-side positive-locking element in a materially engaging manner.

These contacts comprise in this instance at least two sliding rings for contacting with an associated sliding brush and at least one strip conductor which is associated with the respective sliding ring and which extends from the associated sliding ring through the plastics material of the shaft adapter.

In this instance, a separate arrangement of at least two sliding brushes is additionally received by the housing of the locking apparatus for the said remote excitation.

As a result of this proposed function integration, components and consequently structural space are advantageously saved. Consequently, assembly complexity can also advantageously be simplified.

In one aspect of the invention, the electric drive is arranged transversely relative to the shaft. Such a transverse arrangement advantageously provides structural space for receiving the contacts by the housing of the locking apparatus.

The term “transverse” is in this instance intended to be understood to be either an orthogonal arrangement of the electric drive with respect to the shaft or an arrangement in which a longitudinal axis of the electric drive forms an acute or obtuse angle with a longitudinal axis of the lockable shaft.

In one aspect of the invention, the sliding brushes are arranged radially with respect to the shaft. Such a radial arrangement also promotes a compact embodiment of the locking apparatus.

In this instance, it is proposed to place or to contact the sliding brushes in a resiliently pretensioned manner with respect to an associated sliding ring of the contact. A monitoring of sliding brushes which become worn over time with respect to the associated sliding rings is thereby ensured.

There is further proposed an electric motor drive unit, in particular for driving a vehicle having a locking apparatus of the above-described type, which is fitted to a housing of the electric motor of the electric motor drive unit.

In addition, a vehicle having an electric motor drive unit of the above-described type is proposed.

A vehicle is intended in this instance to be understood to be any type of vehicle or motor vehicle which is electromotively operated, but in particular passenger motor vehicles and/or utility vehicles. These are preferably partially autonomously and in particular fully autonomously operated vehicles.

### BRIEF DESCRIPTION OF THE DRAWINGS

The invention is explained in detail below with reference to the illustrations of the Figures. Other advantageous further developments of the invention can be derived from the dependent claims and the following description of preferred embodiments. In the drawings:

FIG. 1A is a perspective view of an electric motor drive unit having a proposed locking apparatus;

FIG. 1B is a perspective and enlarged view of a portion of the locking apparatus;

FIG. 2 is the locking apparatus shown in FIG. 1 as a planar sectioned view;

FIG. 3 is a locking mechanism of the locking apparatus together with an arrangement of contacts;

FIG. 4 is the arrangement of the locking mechanism as shown in FIG. 3 and the contacts as a perspective view;

FIG. 5 is a multi-functional shaft adapter of the locking apparatus;

FIG. 6 is a positive-locking region between a lockable shaft and the locking apparatus as a sectioned view;

FIG. 7 is a perspective and enlarged view of the positive-locking region shown in FIG. 6, and

FIG. 8 is a perspective sectioned view of the locking apparatus.

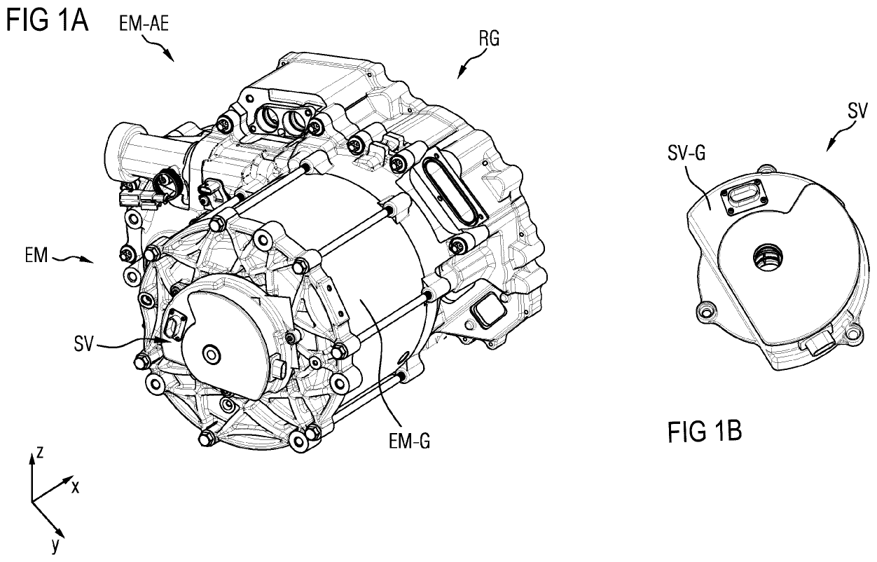

### DETAILED DESCRIPTION OF THE PRESENTLY PREFERRED EMBODIMENTS

The proposed locking apparatus SV is fitted to an electric motor drive unit EM-AE, in particular for driving a vehicle. The electric motor drive unit EM-AE comprises in this instance an electric motor EM in the form of a remotely excited synchronous machine and a reduction gear mechanism RG which is connected thereto. The locking apparatus SV is in this instance arranged on a housing EM-G of the synchronous machine.

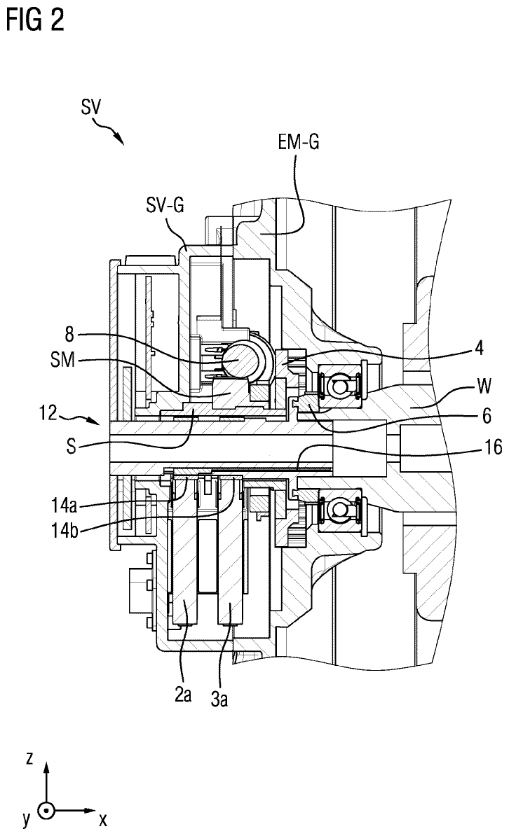

The locking apparatus SV has a locking mechanism and an electric drive EA for actuating the locking mechanism which is received in addition to the drive EA by a housing SV-G of the locking apparatus. For example, FIG. 2 illustrates in this instance very clearly that a housing portion EM-G of the synchronous machine also forms the housing SV-G of the locking apparatus.

The drive EA is in this instance arranged transversely- and orthogonally-with respect to the shaft W or shaft axis X-X. In an embodiment which is not illustrated here, the drive EA may also be arranged with respect to the shaft in such a manner that a longitudinal axis of the drive EA forms an acute or obtuse angle with the longitudinal axis X-X of the shaft W.

The drive EA in this instance drives a helical gear shaft 8 which in turn cooperates with a gear segment 10 of a spindle nut SM with an inner thread. This spindle nut SM is in this instance joined in a longitudinally displaceable manner to a spindle S having a corresponding outer thread which together with the spindle nut SM forms a so-called helical drive or a so-called helical gear transmission which converts a rotational movement of the spindle nut SM (counter-clockwise or clockwise) into a translation movement of the spindle nut SM along the spindle S and in the longitudinal direction X-X or along the shaft W. The spindle S is in this instance arranged to be fixed with respect to the housing SV-G and is supported with respect to the housing SV-G (FIG. 2).

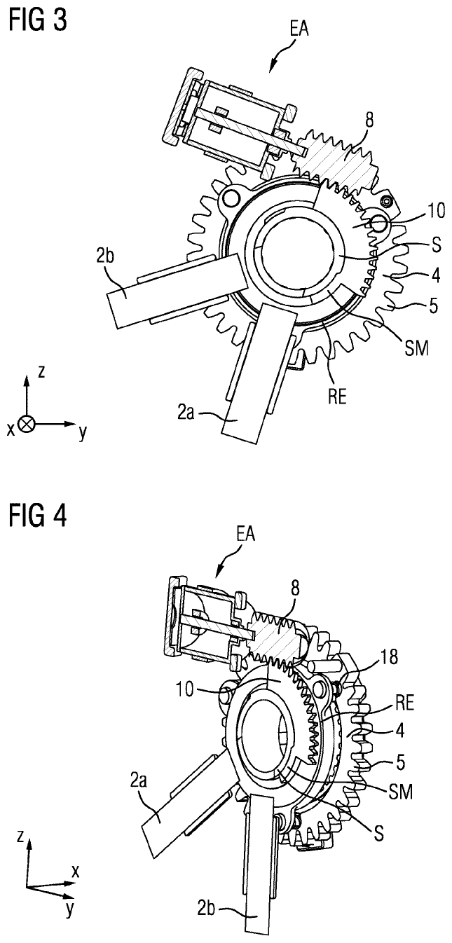

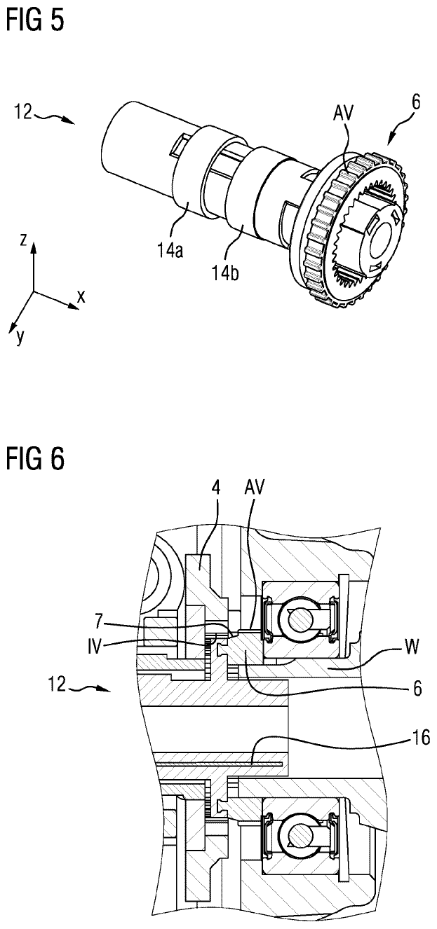

At the shaft side, the spindle nut SM is resiliently pretensioned (FIG. 3, FIG. 4) via a ring element RE which is received by a roller bearing by the spindle nut SM itself in a low-friction manner and individual springs, for instance in the form of helical springs 18, with respect to a positive-locking element 4 which can be actuated in the longitudinal direction X-X or along the shaft W.

This positive-locking element 4 is consequently via these, for instance, three helical springs 18—which are arranged in a state distributed over the circumference of the ring element RE—resiliently connected to a movement mechanism, which brings about the axial travel movement of the positive-locking element 4, of the locking apparatus SV.

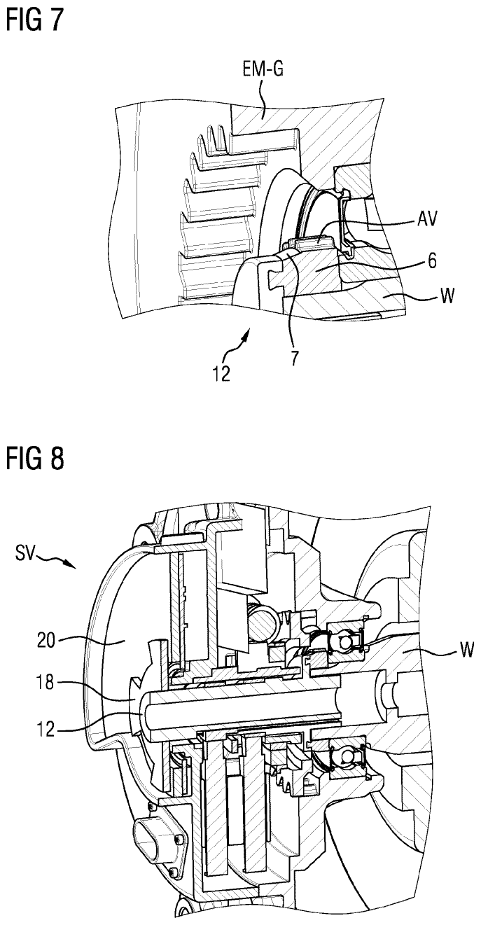

This positive-locking element 4 is in this instance made from metal and configured in a highly resistant manner and is in the form of a closed circumferential, annular element having an inner tooth arrangement IV and an outer tooth arrangement 5. Whilst the inner tooth arrangement IV can be moved into an outer tooth arrangement AV of a shaft-side and metallically highly resistant complement 6 in order to block the shaft W in a positive-locking manner, the outer tooth arrangement 5 always cooperates with a complementarily configured portion of the electric motor housing EM-G in a positive-locking manner. This positive-locking connection ensures a guiding and support of the positive-locking element 4 with respect to the electric motor housing EM-G. This outer tooth arrangement 5 enables in this instance an advantageous or uniform force distribution over the circumference of the positive-locking element 4 and at the same time a favorable or uniform introduction of force into the electric motor housing EM-G. FIG. 7 illustrates in this instance the portion formed on the electric motor housing EM-G to complement the outer tooth arrangement 5 with the inner tooth arrangement thereof. In this instance, the positive-locking element 4 is not illustrated or hidden or omitted for the sake of simplicity.

In the locking state of the shaft W, consequently, both static and dynamic torque loads of the drive train are introduced via this outer tooth arrangement 5 into the electric motor housing EM-G.

Alternatively to the outer tooth arrangement 5, an outer profiling of the positive-locking element 4 may also be provided in the form of individual, radial claw-like projections. In this regard, reference may be made to the German patent applications which have already been mentioned in the introduction with the file references 10 2021 213 737.7 and 10 2021 213 739.3 which describe and illustrate this arrangement.

The locking apparatus SV further has a multi-functional shaft adapter 12 which extends through the spindle S and into a region of the hollow shaft W. This shaft adapter 12 is in this instance substantially produced from a plastics material in which two metal sliding rings 14a, 14b and a metal strip conductor or contact path 16 which is associated with the respective sliding ring 14a, 14b are embedded. The strip conductor 16 extends in this instance from the associated sliding ring 14a, 14b in the direction of the hollow shaft W through the plastics material of the shaft adapter 12.

Furthermore, the plastics material of the shaft adapter 12 is injected or connected in a materially engaging manner with respect to the shaft-side complement 6 which is in the form of a metal adapter ring. FIG. 6 illustrates in this instance by way of example an annular projection of the adapter ring or positive-locking element 6 formed at the end face on the adapter ring 6 and facing the positive-locking element 4 in the form of a dovetail and is enclosed by a plastics material flange of the shaft adapter 12. This adapter ring 6 has in this instance an outer tooth arrangement AV which complements the inner tooth arrangement IV and in addition an inner profiling or inner tooth arrangement, via which the adapter ring 6 and consequently the shaft adapter 12 is pressed onto a correspondingly complementarily formed outer profiling or outer tooth arrangement of the hollow shaft W.

Via the adapter ring 6, the proposed locking apparatus SV can advantageously be adapted to different shaft diameters.

In a state arranged radially with respect to the shaft adapter 12, two sliding brushes 2a, 2b, 3a, 3b are in each case associated with the two sliding rings 14a, 14b and in this instance received by the housing SV-G. The sliding brushes 2a, 2b, 3a, 3b are in this instance applied or contacted in a resiliently pretensioned manner with respect to the associated sliding rings 14a, 14b. In this instance, the sliding brushes 2a, 2b, 3a, 3b which are associated with a sliding ring 14a, 14b and which form a pair are arranged in such a manner with respect to each other that they enclose an angle at the same height (FIG. 3, FIG. 4).

For the purposes of an orientation of the two positive-locking elements 4, 6 with respect to each other, there is formed on the positive-locking element 6 at the end face and facing the positive-locking element 4 a tapering portion 7 which acts in a centering manner (FIG. 6, FIG. 7). In the case of an axial offset between the positive-locking element 4 and the positive-locking element 6 or the hollow shaft W, the inner tooth arrangement IV may during a longitudinal displacement of the positive-locking element 4 in the direction X-X strike against this tapering portion or centering portion 7 in order to be orientated with respect to the outer tooth arrangement AV and consequently the hollow shaft W. The positive-locking element 6 consequently also has in addition to a locking function a centering function which ensures a coaxial orientation of the two positive-locking elements 4, 6 with respect to each other. A uniform force distribution over the circumference of the two positive-locking elements 4, 6 is thereby ensured in the joined state.

The locking apparatus SV further comprises a, for example, inductively acting position sensor arrangement in order to detect a position of the rotor, which is connected to the shaft W, of the synchronous machine in order to enable an efficient electronic commutation of the synchronous machine. FIG. 8 illustrates in this instance, by way of example, a position sensor arrangement in the region of the outer end of the shaft adapter 12 or the end of the shaft adapter 12 which faces away from the shaft end.

In this instance, there is provided a signal transmitter which is fixed with respect to the housing SV-G and which is integrated in a circuit board 20 and which has a coil arrangement which cooperates with a sensor component which is fixed in position with respect to the hollow shaft W in the form of a metal, disk-like element 18 This element 18 arranged opposite the circuit board is in this instance received by the plastics material of the shaft adapter 12 and in a fixed manner with respect to the shaft adapter 12. This element 18 has in this instance at the circumference individual radial, claw-like projections which bring about per se a detuning of a magnetic field acting on them. At least these radial, claw-like projections may in this instance be configured in a magnetic, for example, ferromagnetic manner. In a simple exemplary embodiment, this disk-like element 18 is produced completely from a non-magnetic metal, for instance aluminum.

Alternatively, such a position sensor arrangement may also be provided in the region of the said positive-locking elements 4, 6 or on the shaft.

In this instance, in addition to the said signal transmitter an electronic sensor system for the position sensor arrangement and a motor electronic unit for controlling the electric drive EA is integrated In the circuit board 20.

The proposed locking apparatus represents a compact, structural-space-saving and cost-effective solution within a drive train, in particular of a vehicle in the sense of a parking lock or a locking actuator, according to which the locking mechanism is integrated in the electric motor EM and the locking apparatus is integrated in the electric motor housing EM-G.

In a vehicle with such a locking apparatus, this means that the vehicle in a parking situation in which the vehicle is stationary, for instance, in response to a driver's request, can be locked or blocked.

As long as in this parking situation the orientation of the shaft W is not such that it enables the locking by the positive-locking element 4, the positive-locking element 4 in a state in which it bears at the end face on the shaft-side complement or positive-locking element 6 or on the outer tooth arrangement AV, via the said helical drive-formed by the spindle S and the spindle nut SM- and the said helical springs 18 can be pretensioned or tensioned longitudinally with respect to the shaft W and with a definable force with respect to the shaft W for engagement. If the shaft W is subsequently turned or rotated only slightly further, the positive-locking element 4 engages with the positive-locking element 6 and consequently with the shaft 6 as soon as a corresponding orientation, which enables the engagement, of the shaft W is reached. Such a further turning/rotation of the shaft W in the parking situation may in this instance be brought about by the vehicle system.

However, the said movement play between the two positive-locking elements 4, 6 and in the circumferential direction of the shaft W also enables the following emergency scenario in the event of a malfunction of the vehicle in which the electric motor EM of the electric motor drive unit EM-AE fails.

If there is a failure of the electric motor EM while driving and if the vehicle is subsequently braked to a standstill on a road with a gradient, the proposed locking apparatus SV then enables a locking or blockage of the vehicle which subsequently starts rolling from the stationary state up to a maximum rotation speed of the shaft W in accordance with the movement play or the maximum speed of the vehicle.

In this instance, the positive-locking element 4 is brought into engagement with the positive-locking element 6 and consequently with the shaft W using the movement play and up to the maximum rotation speed of the shaft W in accordance with the movement play or the maximum speed of the vehicle and the vehicle is consequently brought to a standstill.

By the positive-locking element 4, in a state bearing at the end face on the positive-locking element 6 or on the outer tooth arrangement AV, via the helical drive and the helical springs 18 and longitudinally with respect to the shaft W being pretensioned or tensioned into engagement with a definable force with respect to the shaft W, the engagement is finally carried out as soon as the shaft W undergoes a corresponding orientation with respect to the positive-locking element 4.

Although exemplary embodiments have been explained in the preceding description, it should be noted that a large number of modifications are possible. Furthermore, it should be noted that the exemplary embodiments are only examples which are in no way intended to limit the protective scope, the applications and the structure. Instead, the person skilled in the art with the above description is given a guideline for the implementation of at least one exemplary embodiment, wherein various changes, in particular with regard to the function and arrangement of the described components, can be carried out without departing from the protective scope as derived from the claims and these equivalent feature combinations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto

1.-5. (canceled)

6. A locking apparatus for an electric motor drive unit, comprising:
a locking apparatus housing;
a locking mechanism configured to lock a lockable shaft of the electric motor drive unit received by the locking apparatus housing, comprising:
a first positive-locking element having an inner tooth arrangement; and
a second shaft-side positive-locking element having:
an outer tooth arrangement and configured to be actuated with respect to the first positive-locking element in a positive-locking manner in an axial travel movement and longitudinally with respect to the lockable shaft; and
a tapered portion arranged at an end face and facing the first positive-locking element providing a centering action against which the inner tooth arrangement can strike to orientate the first and second positive-locking elements with respect to each other; and
an electric drive configured to actuate the locking mechanism received by the locking apparatus housing.

7. The locking apparatus as claimed in claim 6, further comprising:
a multifunctional shaft adapter received by the locking apparatus housing and configured to connect to the lockable shaft and which is substantially produced from a plastics material and in which contacts for remote excitation of a rotor, which is connected to the lockable shaft, of a synchronous machine of the electric motor drive unit are embedded,
wherein the plastics material of the multifunctional shaft adapter is connected to the second shaft-side positive-locking element in a materially engaging manner.

8. The locking apparatus as claimed in claim 7, wherein the contacts comprise at least two sliding rings for contacting with an associated sliding brush and at least one strip conductor which is associated with a respective sliding ring and which extends from the associated sliding ring through the plastics material of the shaft adapter.

9. An electric motor drive unit for driving a vehicle, comprising:
a locking apparatus fitted to a housing of an electric motor of the electric motor drive unit, comprising:
a locking apparatus housing;
a locking mechanism configured to lock a lockable shaft of the electric motor drive unit received by the locking apparatus housing, comprising:
a first positive-locking element having an inner tooth arrangement; and
a second shaft-side positive-locking element having:
an outer tooth arrangement and configured to be actuated with respect to the first positive-locking element in a positive-locking manner in an axial travel movement and longitudinally with respect to the lockable shaft; and
a tapered portion arranged at an end face and facing the first positive-locking element providing a centering action against which the inner tooth arrangement can strike to orientate the first and second positive-locking elements with respect to each other; and
an electric drive configured to actuate the locking mechanism received by the locking apparatus housing.

10. A vehicle having the electric motor drive unit as claimed in claim 9.
